(19) United States
(12) Patent Application Publication
(10) Pub. No.: US 2022/0353637 A1
(43) Pub. Date: Nov. 3, 2022

(54) METHOD, APPARATUS AND COMPUTER PROGRAM FOR SUPPORTING LOCATION SERVICES REQUIREMENTS

(71) Applicant: NOKIA TECHNOLOGIES OY, Espoo (FI)

(72) Inventors: Afef FEKI, Sceaux (FR); Sankaran BALASUBRAMANIAM, Bangalore (IN); Veronique CAPDEVIELLE, Magny les Hameaux (FR)

(21) Appl. No.: 17/764,416

(22) PCT Filed: Sep. 15, 2020
(86) PCT No.: PCT/EP2020/075721

§ 371 Date: Mar. 28, 2022

(51) Int. Cl. H04W 4/029; H04W 24/02

(52) U.S. Cl. CPC H04W 4/029; H04W 24/02

(57) ABSTRACT

A method comprising: receiving a request for a location of a communication device with information indicating an associated required location quality of service of said location; and in response to said information, determining which of a plurality of location methods to use and one or more parameters for said determined location method.

### FIELD OF THE INVENTION

This disclosure relates to a method and apparatus, and in particular, but not exclusively, to a method and apparatus for determining a location method for determining a location of a device.

### BACKGROUND

A communication system can be seen as a facility that enables communication sessions between two or more entities such as communication devices, base stations/access points and/or other nodes by providing carriers between the various entities involved in the communications path. A communication system can be provided for example by means of a communication network and one or more compatible communications devices.

Access to the communication system may be via an appropriate communications device or terminal. A communications device is provided with an appropriate signal receiving and transmitting apparatus for enabling communications, for example enabling access to a communication network or communications directly with other communications device. The communications device may access a carrier provided by a station or access point, and transmit and/or receive communications on the carrier.

The communication system and associated devices typically operate in accordance with a given standard or specification which sets out what the various entities associated with the system are permitted to do and how that should be achieved.

### SUMMARY

According to an aspect, there is provided a method comprising: receiving a request for a location of a communication device with information indicating an associated required location quality of service of said location; and in response to said information, determining which of a plurality of location methods to use and one or more parameters for said determined location method.

The location quality of service of said location may comprise a location accuracy.

The method may comprise using one of the plurality of locations method with the one or more of the parameters to determine said location for said communications device.

The method may comprise determining a location quality of service of said determined location for said communications device.

The method may comprise using at least one of a different location method and at least one different parameter to determine the location for said communications device when said determined location quality of service of said determined location does not meet the required location quality of service.

Determining the location quality of service of said determined location may be based, at least in part, on a trained neural network.

The trained neural network may be trained with respect to the selected location method.

The trained neural network may be trained offline.

The information indicating the associated location quality of service may comprise one or more of: a quality of service class; and a required latency.

One or more of said one or more parameters may comprise assistance data for said communications device.

The method may comprise requesting said assistance data for said communications device and in response, receiving said assistance data.

The method may comprise receiving said request for the location of the communication device with the information indicating an associated required location quality of service of said location from a location services client.

The method may comprise causing a response to be provided to said location services client comprising the determined location of the communication device with information indicating a location quality of service of said determined location.

According to an aspect, there is provided a method comprising: using a location method with one or more parameters to determine a position for said communications device; determining a location quality of service of said determined position; and, if said determined location quality of service does not meet a required location quality of service for said determined position, using at least one of a different location method and at least one different parameter.

When said determined location quality of service of said determined location does not meet the required location quality of service, the method may comprise using at least one of a different location method and at least one different parameter to determine the location for said communications device.

Determining the location quality of service of said determined location may be based, at least in part, on a trained neural network.

The trained neural network may be trained with respect to the selected location method.

The trained neural network may be trained offline.

The method may comprise receiving a request for a location of a communication device with information indicating an associated required location quality of service of said location.

The method may comprise, in response to said information, determining which of a plurality of location methods to use and one or more parameters for said determined location method.

The location quality of service of said location may comprise a location accuracy.

The information indicating the associated location quality of service may comprise one or more of: a quality of service class; and a required latency.

One or more of said one or more parameters may comprise assistance data for said communications device.

The method may comprise requesting said assistance data for said communications device and in response, receiving said assistance data.

The method may comprise receiving said request for the location of the communication device with the information indicating an associated required location quality of service of said location from a location services client.

The method may comprise causing a response to be provided to said location services client comprising the determined location of the communication device with information indicating a location quality of service of said determined location.

According to an aspect, there is provided a method comprising: using a trained neural network model to determine an accuracy of a determined position for a communications device using one of a plurality of different location methods, said neural network model being trained offline using at least one training set of data for that one of the different location methods.

The trained neural network may be trained with respect to the at least one of the plurality of different location methods.

The trained neural network may be trained offline.

According to an aspect there is provided an apparatus comprising at least one processor and at least one memory including computer code for one or more programs, the at least one memory and the computer code configured, with the at least one processor, to cause the apparatus at least to: receive a request for a location of a communication device with information indicating an associated required location quality of service of said location; and in response to said information, determine which of a plurality of location methods to use and one or more parameters for said determined location method.

The location quality of service of said location may comprise a location accuracy.

The at least one memory and the computer program code may be configured to, with the at least one processor, cause the apparatus at least to use one of the plurality of locations method with the one or more of the parameters to determine said location for said communications device.

The at least one memory and the computer program code may be configured to, with the at least one processor, cause the apparatus at least to determine a location quality of service of said determined location for said communications device.

The at least one memory and the computer program code may be configured to, with the at least one processor, cause the apparatus at least to use at least one of a different location method and at least one different parameter to determine the location for said communications device when said determined location quality of service of said determined location does not meet the required location quality of service.

The at least one memory and the computer program code may be configured to, with the at least one processor, cause the apparatus at least to determining the location quality of service of said determined location based, at least in part, on a trained neural network.

The trained neural network may be trained with respect to the selected location method.

The trained neural network may be trained offline.

The information indicating the associated location quality of service may comprise one or more of: a quality of service class; and a required latency.

One or more of said one or more parameters may comprise assistance data for said communications device.

The at least one memory and the computer program code may be configured to, with the at least one processor, cause the apparatus at least to request said assistance data for said communications device and in response, receive said assistance data.

The at least one memory and the computer program code may be configured to, with the at least one processor, cause the apparatus at least to receive said request for the location of the communication device with the information indicating an associated required location quality of service of said location from a location services client.

The at least one memory and the computer program code may be configured to, with the at least one processor, cause the apparatus at least to cause a response to be provided to said location services client comprising the determined location of the communication device with information indicating a location quality of service of said determined location.

According to an aspect, there is provided an apparatus comprising at least one processor and at least one memory including computer code for one or more programs, the at least one memory and the computer code configured, with the at least one processor, to cause the apparatus at least to: use a location method with one or more parameters to determine a position for said communications device; determining a location quality of service of said determined position; and, if said determined location quality of service does not meet a required location quality of service for said determined position, use at least one of a different location method and at least one different parameter.

The at least one memory and the computer program code may be configured to, with the at least one processor, cause the apparatus at least to use at least one of a different location method and at least one different parameter to determine the location for said communications device when said determined location quality of service of said determined location does not meet the required location quality of service.

The at least one memory and the computer program code may be configured to, with the at least one processor, cause the apparatus at least to determine the location quality of service of said determined location based, at least in part, on a trained neural network.

The trained neural network may be trained with respect to the selected location method.

The trained neural network may be trained offline.

The at least one memory and the computer program code may be configured to, with the at least one processor, cause the apparatus at least to receive a request for a location of a communication device with information indicating an associated required location quality of service of said location.

The at least one memory and the computer program code may be configured to, with the at least one processor, cause the apparatus at least to determine which of a plurality of location methods to use and one or more parameters for said determined location method in response to said information.

The location quality of service of said location may comprise a location accuracy.

The information indicating the associated location quality of service may comprise one or more of: a quality of service class; and a required latency.

One or more of said one or more parameters may comprise assistance data for said communications device.

The at least one memory and the computer program code may be configured to, with the at least one processor, cause the apparatus at least to request said assistance data for said communications device and in response, receiving said assistance data.

The at least one memory and the computer program code may be configured to, with the at least one processor, cause the apparatus at least to receive said request for the location of the communication device with the information indicating an associated required location quality of service of said location from a location services client.

The at least one memory and the computer program code may be configured to, with the at least one processor, cause the apparatus at least to cause a response to be provided to said location services client comprising the determined location of the communication device with information indicating a location quality of service of said determined location.

According to an aspect, there is provided an apparatus comprising at least one processor and at least one memory including computer code for one or more programs, the at least one memory and the computer code configured, with the at least one processor, to cause the apparatus at least to: use a trained neural network model to determine an accuracy of a determined position for a communications device using one of a plurality of different location methods, said neural network model being trained offline using at least one training set of data for that one of the different location methods.

The trained neural network may be trained with respect to the at least one of the plurality of different location methods.

The trained neural network may be trained offline.

According to an aspect, there is provided an apparatus comprising means for: receiving a request for a location of a communication device with information indicating an associated required location quality of service of said location; and in response to said information, determining which of a plurality of location methods to use and one or more parameters for said determined location method.

The location quality of service of said location may comprise a location accuracy.

The means may be for using one of the plurality of locations method with the one or more of the parameters to determine said location for said communications device.

The means may be for determining a location quality of service of said determined location for said communications device.

The means may be for using at least one of a different location method and at least one different parameter to determine the location for said communications device, when said determined location quality of service of said determined location does not meet the required location quality of service.

The means may be for determining the location quality of service of said determined location based, at least in part, on a trained neural network.

The trained neural network may be trained with respect to the selected location method.

The trained neural network may be trained offline.

The information indicating the associated location quality of service may comprise one or more of: a quality of service class; and a required latency.

One or more of said one or more parameters may comprise assistance data for said communications device.

The means may be for requesting said assistance data for said communications device and in response, receiving said assistance data.

The means may be for receiving said request for the location of the communication device with the information indicating an associated required location quality of service of said location from a location services client.

The means may be for causing a response to be provided to said location services client comprising the determined location of the communication device with information indicating a location quality of service of said determined location.

According to an aspect, there is provided an apparatus comprising means for: using a location method with one or more parameters to determine a position for said communications device;

determining a location quality of service of said determined position; and, if said determined location quality of service does not meet a required location quality of service for said determined position, using at least one of a different location method and at least one different parameter.

The means may be for using at least one of a different location method and at least one different parameter to determine the location for said communications device when said determined location quality of service of said determined location does not meet the required location quality of service.

The means may be for determining the location quality of service based, at least in part, on a trained neural network.

The trained neural network may be trained with respect to the selected location method.

The trained neural network may be trained offline.

The means may be for receiving a request for a location of a communication device with information indicating an associated required location quality of service of said location.

The means may be for determining which of a plurality of location methods to use and one or more parameters for said determined location method in response to said information.

The location quality of service of said location may comprise a location accuracy.

The information indicating the associated location quality of service may comprise one or more of: a quality of service class; and a required latency.

One or more of said one or more parameters may comprise assistance data for said communications device.

The means may be for requesting said assistance data for said communications device and in response, receiving said assistance data.

The means may be for receiving said request for the location of the communication device with the information indicating an associated required location quality of service of said location from a location services client.

The means may be for causing a response to be provided to said location services client comprising the determined location of the communication device with information indicating a location quality of service of said determined location.

According to an aspect, there is provided an apparatus comprising means for: using a trained neural network model to determine an accuracy of a determined position for a communications device using one of a plurality of different location methods, said neural network model being trained offline using at least one training set of data for that one of the different location methods.

The trained neural network may be trained with respect to the at least one of the plurality of different location methods.

The trained neural network may be trained offline.

According to an aspect, there is provided a computer program comprising computer executable code which when run on at least one processor is configured to cause an apparatus at least to receive a request for a location of a communication device with information indicating an associated required location quality of service of said location; and in response to said information, determine which of a plurality of location methods to use and one or more parameters for said determined location method.

According to an aspect, there is provided a computer program comprising computer executable code which when run on at least one processor is configured to cause an apparatus at least to use a location method with one or more parameters to determine a position for said communications device; determine a location quality of service of said determined position; and, if said determined location quality of service does not meet a required location quality of service for said determined position, use at least one of a different location method and at least one different parameter.

According to an aspect, there is provided a computer program comprising computer executable code which when run on at least one processor is configured to cause an apparatus at least to use a trained neural network model to determine an accuracy of a determined position for a communications device using one of a plurality of different location methods, said neural network model being trained offline using at least one training set of data for that one of the different location methods.

According to an aspect there is provided a computer program comprising computer executable code which when run on at least one processor is configured to cause any of the previously described methods to be performed.

According to an aspect, there is provided a computer readable medium comprising program instructions stored thereon for performing: receiving a request for a location of a communication device with information indicating an associated required location quality of service of said location; and in response to said information, determining which of a plurality of location methods to use and one or more parameters for said determined location method.

According to an aspect, there is provided a computer readable medium comprising program instructions stored thereon for performing: using a location method with one or more parameters to determine a position for said communications device; determining a location quality of service of said determined position; and, if said determined location quality of service does not meet a required location quality of service for said determined position, using at least one of a different location method and at least one different parameter.

According to an aspect, there is provided a computer readable medium comprising program instructions stored thereon for performing: using a trained neural network model to determine an accuracy of a determined position for a communications device using one of a plurality of different location methods, said neural network model being trained offline using at least one training set of data for that one of the different location methods.

According to an aspect, there is provided a computer readable medium comprising program instructions stored thereon for performing at least one of the above methods.

According to an aspect, there is provided a non-transitory computer readable medium comprising program instructions stored thereon for performing: receiving a request for a location of a communication device with information indicating an associated required location quality of service of said location; and in response to said information, determining which of a plurality of location methods to use and one or more parameters for said determined location method.

According to an aspect, there is provided a non-transitory computer readable medium comprising program instructions stored thereon for performing: using a location method with one or more parameters to determine a position for said communications device; determining a location quality of service of said determined position; and, if said determined location quality of service does not meet a required location quality of service for said determined position, using at least one of a different location method and at least one different parameter.

According to an aspect, there is provided a non-transitory computer readable medium comprising program instructions stored thereon for performing: using a trained neural network model to determine an accuracy of a determined position for a communications device using one of a plurality of different location methods, said neural network model being trained offline using at least one training set of data for that one of the different location methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

According to an aspect, there is provided an apparatus comprising receiving circuitry for a request for a location of a communication device with information indicating an associated required location quality of service of said location; determining circuitry for determining which of a plurality of location methods to use and one or more parameters for said determined location method in response to said information.

According to an aspect, there is provided an apparatus comprising determining circuitry for using a location method with one or more parameters to determine a position for said communications device; determining circuitry for determining a location quality of service of said determined position; and, circuitry for using at least one of a different location method and at least one different parameter if said determined location quality of service does not meet a required location quality of service for said determined position.

According to an aspect, there is provided an apparatus comprising circuitry for using a trained neural network model to determine an accuracy of a determined position for a communications device using one of a plurality of different location methods, said neural network model being trained offline using at least one training set of data for that one of the different location methods.

In the above, many different aspects have been described. It should be appreciated that further aspects may be provided by the combination of any two or more of the aspects described above.

Various other aspects are also described in the following detailed description and in the attached claims.

### BRIEF DESCRIPTION OF FIGURES

Some example embodiments will now be described in further detail, by way of example only, with reference to the following examples and accompanying drawings, in which:

FIG. 1 shows a schematic example of a communication system;

FIG. 2 shows an example of a communication device;

FIG. 3 illustrates an example of a non-transitory computer readable medium;

FIG. 4 shows a schematic diagram of an example apparatus;

FIG. 5 illustrates an architecture for location services in service based representation;

FIG. 6 shows a method used in some embodiments;

FIG. 7 shows a signal flow of some embodiments;

FIG. 8 schematically shows an example of an offline procedure for step 3 of FIG. 6;

FIG. 9 schematically shows an example of an online procedure for step 3 of FIG. 6;

FIG. 10 shows an example of a decision tree with machine learning based location method;

FIG. 11 shows an example of data generated to train a neural network NN model;

FIG. 12 shows performance when applying the trained NN model on a set of test data; and

FIGS. 13 to 15 show example methods according to some example embodiments.

### DETAILED DESCRIPTION

As is known, wireless systems can be divided into cells, and are therefore often referred to as cellular systems. Typically, an access point such as a base station provides at least one cell. The cellular system can support communications between user equipment (UE). The present disclosure relates to cellular radio implementation, including 2G, 3G, 4G, and 5G radio access networks (RANs); cellular internet of things (IoT) RAN; and cellular radio hardware.

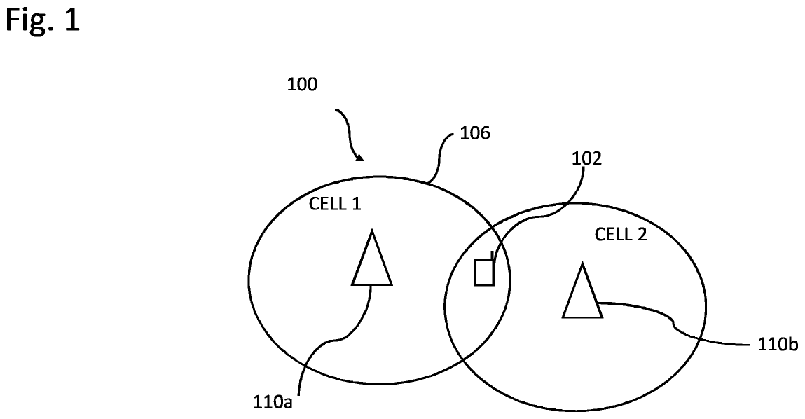

In the following certain embodiments are explained with reference to communications devices capable of communication via a wireless cellular system and communication systems serving such communications devices. Before explaining in detail the exemplifying embodiments, certain general principles of a wireless communication system, access systems thereof, and communications devices are briefly explained with reference to FIGS. 1 to 4 to assist in understanding the technology underlying the described examples.

An example of wireless communication systems are architectures standardized by the 3rd Generation Partnership Project (3GPP). A latest 3GPP based development is often referred to as 5G or New Radio (NR). Other examples of radio access system comprise those provided by base stations of systems that are based on technologies such as wireless local area network (WLAN) and/or WiMAX (Worldwide Interoperability for Microwave Access). It should be appreciated that although some embodiments are described in the context of a 5G system, other embodiments may be provided in any other suitable system including but not limited to subsequent systems or similar protocols defined outside the 3GPP forum.

FIG. 1 which shows a section of a wireless communication system 100. As can be seen a communications device 102 are served by cell 1 106 which is provided by a first base station 110a. In this example, the communications device 102 may be served by a second cell, cell 2, which is provided by a second base station 110b. The base station may be any suitable transmission reception point TRP depending on the system. For example, the TRP (sometimes referred to as TRxP) may be a gNB or a ng-eNB.

The communication device will be referred to as a UE (user equipment) in this document but it should be appreciated that the device may be any suitable communications device and the term UE is intended to cover any such device. Some examples of communications devices are discussed below and as used in this document the term UE is intended to cover any one or more of those devices and/or any other suitable device. The communications devices have a wireless connection to a base station.

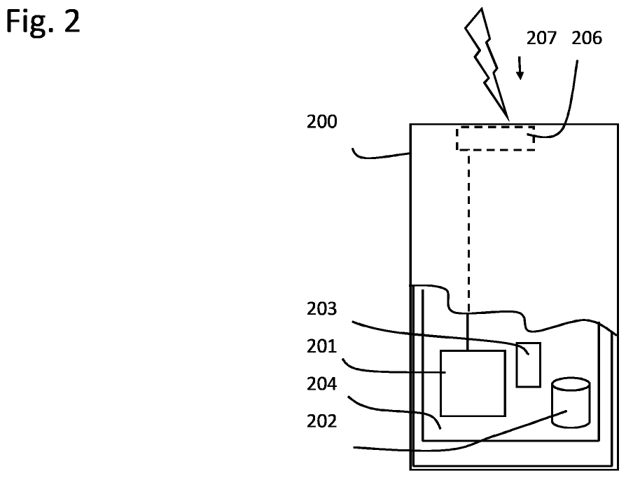

FIG. 2 illustrates an example of a communications device 200, such as the wireless communications device 102 shown on FIG. 1. The wireless communications device 200 may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, machine-type communications (MTC) devices, IoT type communications devices or any combinations of these or the like.

The device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

The wireless communications device 200 may be provided with at least one processor 201 and at least one memory 202. The at least one memory may comprise at least one ROM and/or at least one RAM. The communications device may comprise other possible components 203 for use in software and hardware aided execution of tasks it is designed to perform, including control of access to and communications with access systems and other communications devices. The at least one processor 201 is coupled to the at least one memory 202. The at least one processor 201 may be configured to execute an appropriate software code to implement one or more of the following aspects. The software code may be stored in the at least one memory 202, for example in the at least one ROM.

The processor, storage and other relevant control apparatus can be provided on an appropriate circuit board and/or in chipsets. This feature is denoted by reference 204.

The device may optionally have a user interface such as key pad, touch sensitive screen or pad, combinations thereof or the like.

Optionally one or more of a display, a speaker and a microphone may be provided depending on the type of the device.

Communication protocols and/or parameters which shall be used for the connection are also typically defined. The communications devices may access the communication system based on various access techniques.

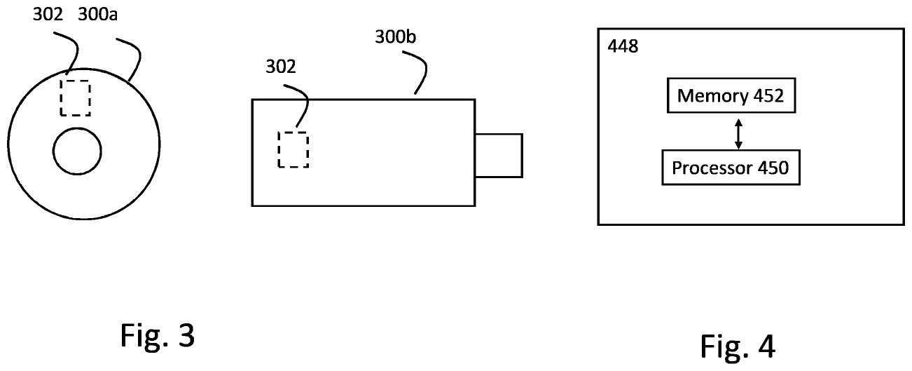

FIG. 3 shows a schematic representation of non-volatile memory media 300a (e.g. computer disc (CD) or digital versatile disc (DVD)) and 300b (e.g. universal serial bus (USB) memory stick) storing instructions and/or parameters 302 which when executed by a processor allow the processor to perform one or more of the steps of any of the methods of any of the embodiments.

FIG. 4 shows an apparatus 448. The apparatus 448 may be provided in any of the network entities. The apparatus may comprise at least processor 450 and at least one memory 452 including computer code for one or more programs. In some embodiments, the apparatus may be provided in for example the LMF.

This apparatus may be configured to cause some embodiments to be performed.

One or more of the following aspects relate to a 5G system (5GS). The new radio interface introduced as part of 5GS is called new radio (NR). However, it will be understood that some of these aspects may be used with any other suitable radio access technology systems such as UTRAN (3G radio), the long-term evolution (LTE) of the Universal Mobile Telecommunications System (UMTS) and/or any other suitable system.

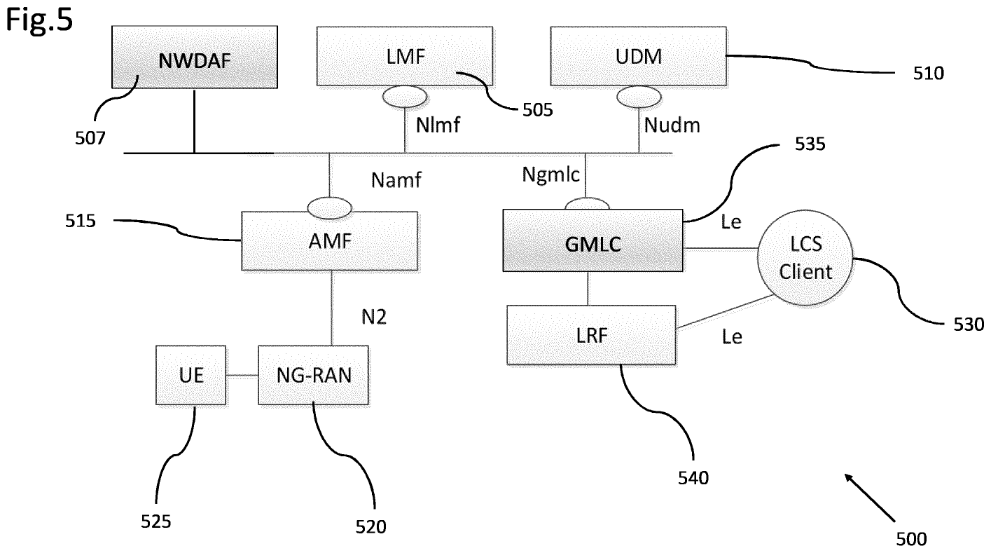

Reference is made to FIG. 5, which illustrates a non-roaming architecture 500, illustrating various functions that may be provided by a network in addition to the communication devices and their interfaces to the network. Some of these functions may be provided by the core network. Example embodiments of the application may be provided by such a network that provides these functions. Although reference is made here, and elsewhere in the description, to a UE, it would be understood by the skilled person that the device need not be a UE, but may be another type of communications device.

The Location Management Function (LMF) 505 of the architecture 500 is responsible for supporting location determination for a UE, determining a location estimate from a UE, obtain location measurements from the radio access network, and obtaining non-UE assistance data from the radio access network. The Unified Data Management (UDM) function 510 of the architecture 500 stores subscription information and supports the Authentication Credential Repository and Processing Function and stores security credentials used for authentication. The access and mobility management function (AMF) 515 is configured to perform a plurality of tasks including: Registration Management, Connection Management, Reachability Management, Mobility Management and various function relating to security and access management and authorization. The AMF 515 provides these services for devices, such as UE 525, configured to communicate with the core network.

The Radio Access Network (shown as NG-RAN) 520 is configured to provide access to the core network for the UE 525. The radio access network 520 comprises one or more base stations and one or more associated radio network controllers.

The Network Data Analytics Function (NWDAF) 507 is configured to perform data analysis upon request from one or more Network Functions in the 5G Network.

There is also provided an external client (or location services client) 530 configured to send and receive communications towards the core network. The Gateway Mobile Location Centre (GMLC) 535 contains functionality required to support Location based services, and therefore, interfaces with the external client 535. The location retrieval function (LRF) 540 can be used for retrieving location information for users that initiated an emergency session.

The UE location information can be used by the network for Radio Resource Management (RRM).

Location information may be also used in order to provide critical emergency services.

To this end, different methods have been proposed which are generally based on L1/L2 measurements. These methods may allow the UE location to be with a given precision. Common location methods employed in the network include Observed Time Difference of Arrival (OTDOA) Positioning, enhanced Cell ID method (E-CID) and Global Navigation Satellite System (GNSS).

The precision/accuracy of the estimated location may depend on the employed location method, its configuration (e.g. periodicity of the measurements), on the radio environment, and on the actual position of the user in this environment. In order to optimize the possible location methods, the accuracy of the estimated location should be in accordance with the targeted usage of this location information.

Some embodiments may be in the context of user positioning in 5G, at Core and NR.

Some embodiments, the LMF may expose its services to external/internal clients using a Service Based API.

A LCS (Location services) QoS may be provided to be used by clients. The QoS structure may include one or more of:
QoS Class: For example ‘Best Effort Class’ and/or ‘Assured Class’
Required Location Accuracy
Required Latency etc.

The QoS structure may, for example, be a structure as defined by 3GPP Rel-16.

Some embodiments may cause the location architecture to ensure that the QoS parameters are met, particularly when the QoS Class is the “Assured Class”.

Some embodiments may provide a procedure to achieve a required QoS. Some embodiments may allow the required location accuracy to be achieved.

Some embodiments provide a method that allows the LMF (Location Management Function) to ensure that the required QoS values are met. Some embodiments may use a closed loop approach.

In some embodiments, a machine learning based model may be used.

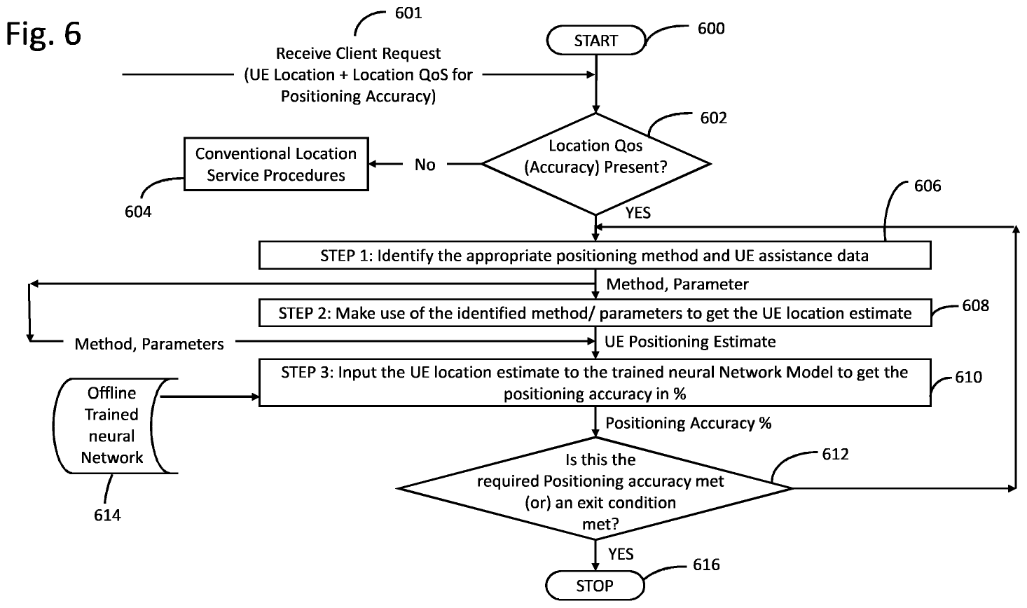

Reference is made to FIG. 6 which shows a flowchart. This flowchart may be implemented in an apparatus in the LMF.

As referenced 600, the method is started.

A client request 601 is received. This request may be for a location of a UE or the like. The request may have a location quality of service for positioning accuracy specified.

As referenced 602, a determination is made as to whether a location QoS accuracy is in the request.

If no, then as referenced 604, one or more conventional location service procedures may be provided to provide the requested location of the UE.

Some embodiments aim to provide selection of an appropriate location method for the required location and if necessary to provide a refinement when the selected location method is unable to provide the targeted accuracy.

If yes, then as referenced 606, step 1 of a closed loop approach is performed. In this step, the appropriate positioning method and UE assistance data is determined or identified. This may also identify one or more appropriate parameters.

Next, as referenced 608, step 2 of the closed loop approach is applied. The location method(s) identified in step 1 are applied. The UE's position estimate is derived and stored in the LMF. Optionally, time information can be stored for the output geographical positions (e.g. for a Recurrent Neural Network application)

It should be appreciated that any one or more suitable positioning method may be selected and used in steps 1 and 2.

Next, as referenced 610, step 3 of the closed loop approach is applied. The aim of this step is to derive the achieved positioning accuracy based on the stored UE positions from step 2 along with the selected parameters of the selected location methods of step 1.

In some embodiments, the UE location estimate is provided as an input to a trained neural network model to determine the position accuracy. This positioning accuracy may in some embodiments be expressed as a percentage value or as a mean square value or in any suitable way.

In some embodiments, any suitable supervised machine learning ML may be used. As mentioned, in some embodiments a Neural Network (NN) is used. Other ML may alternatively or additionally be used.

Step 3 may have two phases. There may be an offline training phase, referenced 614, which allows for the selection and training of a neural network architecture based on a known dataset.

In some example embodiments, the offline training phase 614 may be performed at the NWDAF or the LMF.

Thereafter, this trained neural network is used in the online computation of UE positioning accuracy in step 3. Step 3 is described in more detail later.

As referenced 612, the positioning is compared to the required threshold. If the positioning accuracy condition is not satisfied, then a closed loop is performed to return to Step 1 and perform a new selection of an appropriate positioning method. This may be in the form of a refinement of the parameters of the previously identified location method(s) (such as reporting period of positioning reference signals (PRS)), or selection of another positioning method.

In some embodiments, an exit condition may be defined at this level in order to allow this closed loop to be exited. For example, there may be a limit on the number of iterations of the loop or there may be a limit on the amount of time for which the loop is allowed to run. This exit condition may be triggered when the convergence to the desired location accuracy is taking too long.

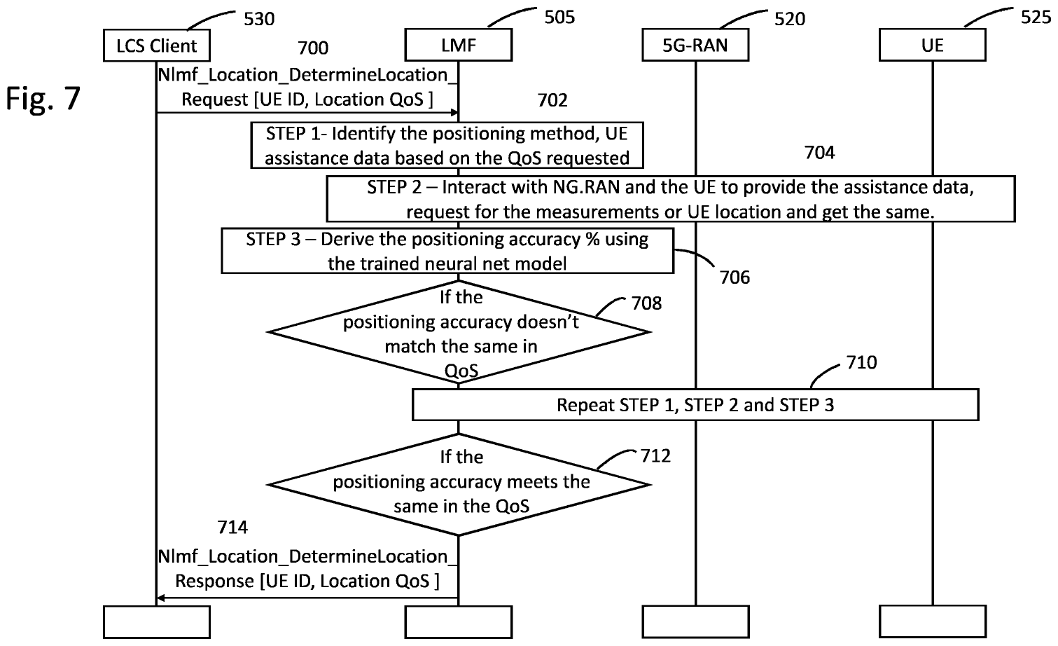

Reference is made to FIG. 7 which shows a signal flow of some embodiments.

In step 700, a message is sent from the LCS client 530 to the LMF 505. This message may be a location request. This location request may be a Nlmf location request requesting a determined location. (For example, the message may be a Nlmf_Location_DerterminedLocation_Request) The request may comprise the identity of a user equipment and the required location quality of service or accuracy.

Step 1 of FIG. 6 is performed by the LMF 505. This is referenced 702. Thus, the LMF will determine or identify the positioning method to be used. The LMF will determine or identity the required UE assistance data based on the quality of service or accuracy.

As shown in FIG. 7, Step 2 of FIG. 6 is performed in conjunction with the LMF 505, the 5G-RAN 520 and the UE 525. This is referenced 704. The LMF will interact with the 5G-RAN and the UE to obtain the required assistance data. The LMF may request and receive measurements associated with the UE. The LMF will use this information to provide a UE location estimate.

Step 3 of FIG. 6 is performed in the LMF. This is referenced 706. The LMF will derive the accuracy of the location estimate provided in step 2 using the trained neural network model.

As referenced 708, the LMF is configured to determine if the positioning accuracy meets the required threshold. This corresponds to step 612 of FIG. 6.

As indicated by reference 710, step 1, step 2 and step 3 may be repeated as required. This will be if the positioning accuracy does not meet the required threshold.

As indicated by reference 712, where the positioning accuracy meets the required threshold. When the addition in accuracy meets that the required threshold, the LMF 505 is configured to cause a response to be sent to the LCS client 530. This will provide the UE identity and the determined location of the UE. Optionally this may include an indication of the accuracy of the determined location. This may be a Nlmf location response. (For example a Nlmf_Location_DeterminedLocation_Response). This is referenced 714 in FIG. 7.

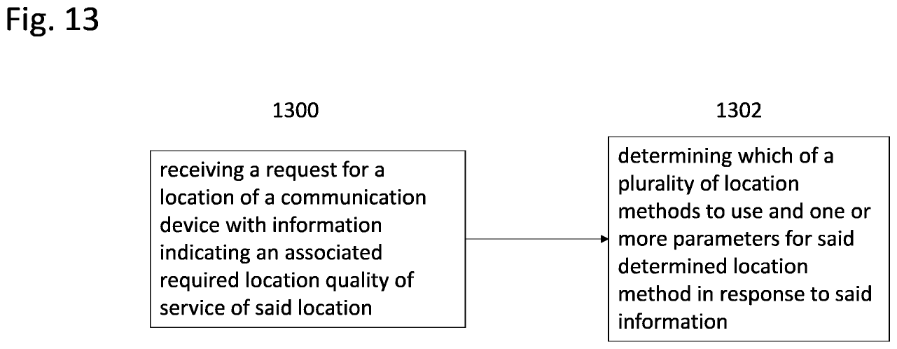

Reference is made to FIG. 13, which shows a method according to some example embodiments.

As indicated by reference 1300, the method may comprise receiving a request for a location of a communication device with information indicating an associated required location quality of service of said location.

As indicated by reference 1302, the method may comprise determining which of a plurality of location methods to use and one or more parameters for said determined location method in response to said information.

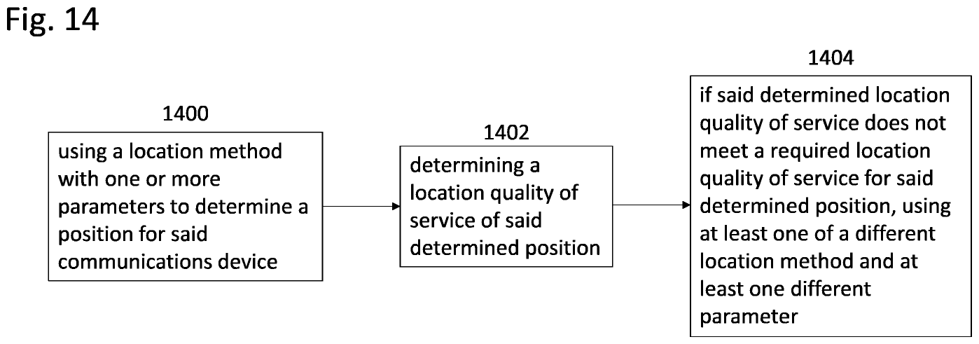

Reference is made to FIG. 14, which shows a method according to some example embodiments.

As indicated by reference 1400, the method may comprise using a location method with one or more parameters to determine a position for said communications device.

As indicated by reference 1402, the method may comprise determining a location quality of service of said determined position.

As indicated by reference 1404, the method may comprise, if said determined location quality of service does not meet a required location quality of service for said determined position, using at least one of a different location method and at least one different parameter.

In some example embodiments, the example methods shown in FIGS. 13 and 14 may be performed by an apparatus, such as but not limited to the LMF, or by an apparatus comprised in the LMF.

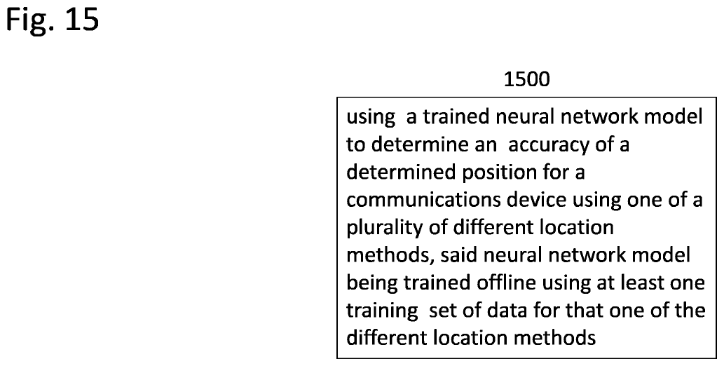

Reference is made to FIG. 15, which shows a method according to some example embodiments.

As indicated by reference 1500, the method may comprise using a trained neural network model to determine an accuracy of a determined position for a communications device using one of a plurality of different location methods, said neural network model being trained offline using at least one training set of data for that one of the different location methods.

In some example embodiments, the example method shown in FIG. 15 may be performed by an apparatus, such as but not limited to the LMF or NWDAF, or by an apparatus comprised in the LMF or NWDAF.

Some embodiments may ensure the positioning accuracy in use cases where it may be critical or important.

The use of the ML may be suited to positioning applications as such applications generate a large quantity of data.

Some embodiments may be such that training of the model may be specific to specific locations. This may ensure that the accuracy of the model is improved.

It should be appreciated that one or more other parameters may be added into the model. These parameters may require the model to be updated and/or trained to use these one or more additional parameters. This may be relatively simple to implement in practice.

Based on required location QoS, this LMF needs to be able to identify or determine the appropriate location methods that should be run in step 1. This may take into account just the required QoS value or also for the status/results from one or more previous iterations of the closed loop for particular request.

There are a number of different ways in which this determination of an appropriate method may be carried out.

For example a look up table may be used. An example of a table is given below. OTDOA is observed time of arrival. The values and methods in the table are provided purely by way of example.

| | | Location | | | |
|---|---|---|---|---|---|
| Location QoS | | update period | Method | Parameters | |
| 10 | m | 30 ms | OTDOA | 3 | gNB |
| 5 | m | 30 ms | OTDOA | 4 | gNBs |
| 2 | m | 30 ms | OTDOA | 5 | gNBs |

| | | | | |
|---|---|---|---|---|
| 6 | m | 10 ms | ML with NN | 1 cell & 1 beam |
| 3 | m | 10 ms | ML with NN | 1 cell & 4 beams |
| 2 | m | 10 ms | ML with NN | 2 cells & 4 beams |

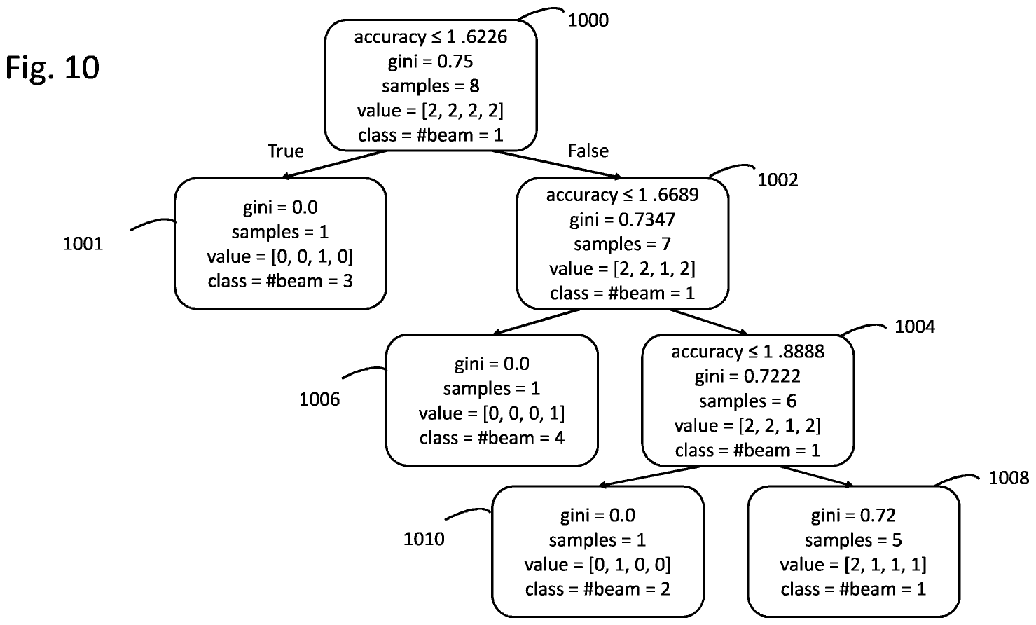

In other embodiments a ML based method is used. In this regard, reference is made to FIG. 10 which shows a decision tree.

Regardless of the ways of identifying a location method, if an identified or determined location method with corresponding parameters does not correspond to the active configuration, then the LMF may need to request a new configuration from the network e.g. number of reported beam RSRP (reference signal received power) Measurements, PRS (Positioning Reference Signal) period etc.,

Reference is made to FIG. 10, which shows a representation of a decision tree according to some example embodiments.

In some example embodiments, the decision tree may comprise a plurality of nodes. Each node in the decision tree may comprise a gini score, a number of samples, a value, and a class.

The gini score may indicate whether the samples contained within a node belong to the same class, or to different classes. For example, a gini score of zero may indicate that all samples within a node belong to the same class, whereas a gini score greater than zero may indicate that two or more of the samples within the node belong to different classes.

The number of samples indicates how many samples are being assessed by the node.

The value list indicates how many of the total number of samples in the node fall in to each category.

The class value indicates a prediction for a given node based on the value list. In the example of FIG. 10, the achievable accuracy is considered as a function of a number of beam RSRP measurements. The class value therefore is indicative of a number of beam measurements.

Each node may define a point in the decision tree where a determination is performed. For example, as shown in FIG. 10, at a first node 1000, a determination is made as to whether the accuracy is less than or equal to 1.6226 m. Based on the result of the determination, either the true path or the false path will be taken. For example, as can be seen in FIG. 10, if the determination performed at the first node 1000 is true, then the decision tree progresses to node 1001, whereas if the determination performed at the first node 1000 is false, then the decision tree progresses to node 1002.

As can be seen from the example of FIG. 10, the first node 1000 in the tree has eight samples (samples=8). The gini score of 0.75 indicates that some of the samples belong to different classes (i.e. different number of beam measurements for the given accuracy of <1.6226 m). The value list indicates that the eight samples are split evenly across four different classes.

At the first node 1000, a determination as to whether the eight samples meet the condition of accuracy <1.6226 m is performed for each sample. Node 1001, which follows the true branch for the determination performed at node 1000, indicates that only one of the eight samples (samples=1) meets this criteria, following three beam measurements (class=#beam=3). The other seven samples follow the false branch, and are located at node 1002.

At node 1002, a second determination is made, based on a condition of accuracy <1.6689 m.

Those samples that meet the condition follow the true branch to node 1006, and those samples that do not meet the condition follow the false branch to node 1004.

This process is repeated until a final condition is analysed. In the example of FIG. 10, the final condition to be analysed is accuracy <1.888 m, which is performed at node 1004. From this node, samples either follow a true branch to node 1010 or a false branch to node 1008 in the same manner as described previously.

Thus the decision tree performs analysis at various stages in a sequence of decisions. At each stage, a node comprising the aforementioned condition, gini, samples, value, and class, defines a determination to be performed. Following each determination, a sample is passed either to a first node when the condition of a parent node is met, or to a second node when the condition of the parent node is not met.

The decision tree may therefore enable the ML based method to iteratively determine an appropriate machine learning method along with associated parameters in order to reach a target accuracy.

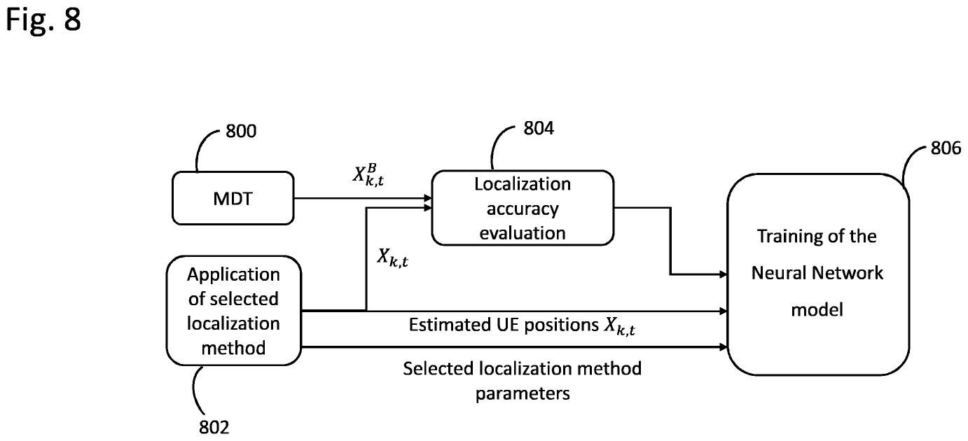

Reference is made to FIG. 8 which shows the offline procedure for training of the NN.

The training of the Neural Network model, referenced 806 in FIG. 8, may be performed based on a dataset of known input-output pairs, where for user k and timet:
Inputs to the NN model 806 comprise one or more of the following:
   UE positions (as processed by a given location method (referenced 802 such as UL-TDOA/DL-TDOA etc., {X_{k,t}}
   The parameters used in the selected location method to estimate the above UE positions
   Benchmark positioning values such as GNSS (denoted as X_{k,t}^{B}). MDT (Minimization of Drive tests) 800 may be employed in order to request UE to report this information
   Corresponding location accuracy evaluation in % provided by block 804: {δ_{k,t}}. This accuracy can be evaluated with a benchmark such as GNSSδ_{k,t}=∥X_{k,t}^{B}−X_{k,t}∥. The location accuracy evaluation receives the benchmark value from the MDT block and the estimated UE position from block 802. The accuracy could be measured in different ways in different embodiments, for example be by a mean square error, %, with different normalization.

This training may be tailored for a given location method.

In some embodiments a dedicated training procedure for each location method may be provided.

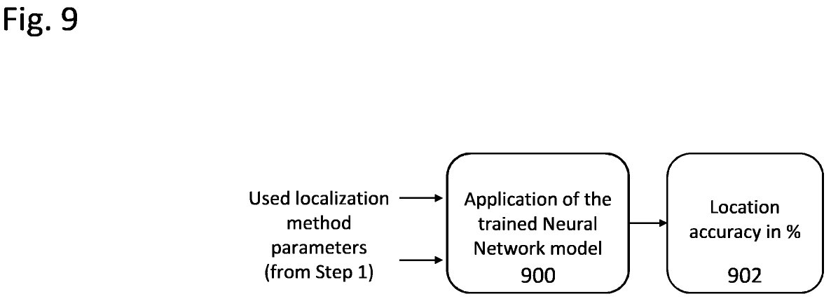

Reference is made to FIG. 9 which shows an application of the NN model 900 which has been trained, for example as discussed in relation to FIG. 8. The application of the NN model may provide a location accuracy, expressed as a percentage 902.

The aim of step 3 is to provide an estimation of the achieved location accuracy. The machine learning based method estimates the location accuracy based on the identified localization method parameters (in step 1) and the estimated UE position(s) (in step 3). This is provided as an output 902 of the NN model 900.

A Neural Network (NN) implementation is used in some embodiments. This supervised learning approach can run in online manner; after the completion of a training phase in an offline manner as discussed in relation to FIG. 8.

A simulation of the proposed ML approach will now be described. The location method is a ML based approach which computes the UE location based on reported radio measurements (beam RSRP). The location method parameters are the number of reported beams. The considered scenario is an indoor case with a floor in Mori Tower, where the base stations are configured with a grid of beam configuration (comprising 32 beams). The frequency used was 28 GHz.

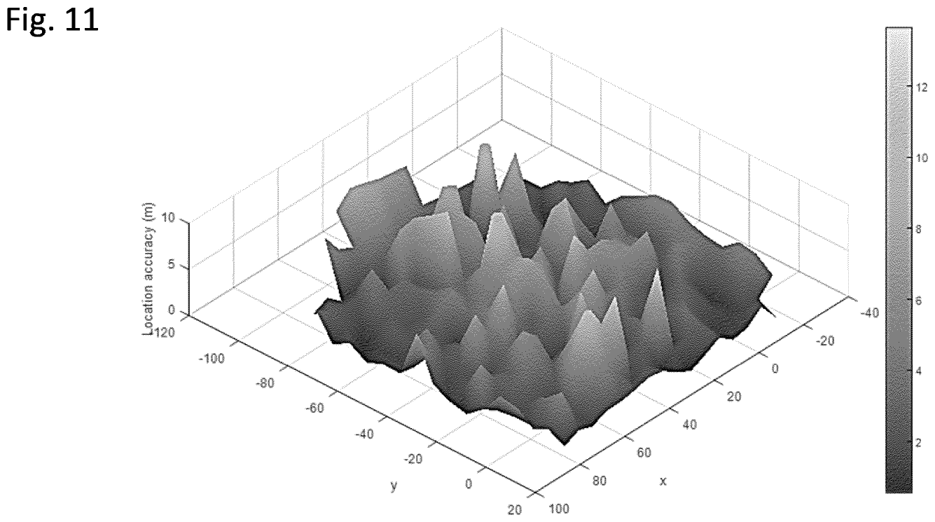

FIG. 11 show the data generated from the application of ML location method with 4 beams reporting from the serving cell. This data set was used to train the NN model previously described. The axes x and y correspond to the estimated UE positions in 2D dimensions {X_{k,t}} and the z axis shows the corresponding location accuracy {δ_{k,t}} for each UE position.

The dataset shown in FIG. 11 corresponds to the complete set of Input-output pairs. The considered location method parameters is 4 (Number of reported beams RSRP). The dataset is split into disjoint training set and test set. The training set is used to train the defined NN model with the following configuration: num_hidden_nodes=100; num_hidden_layers=1; num_epochs=2000; activation function=‘tanh’.

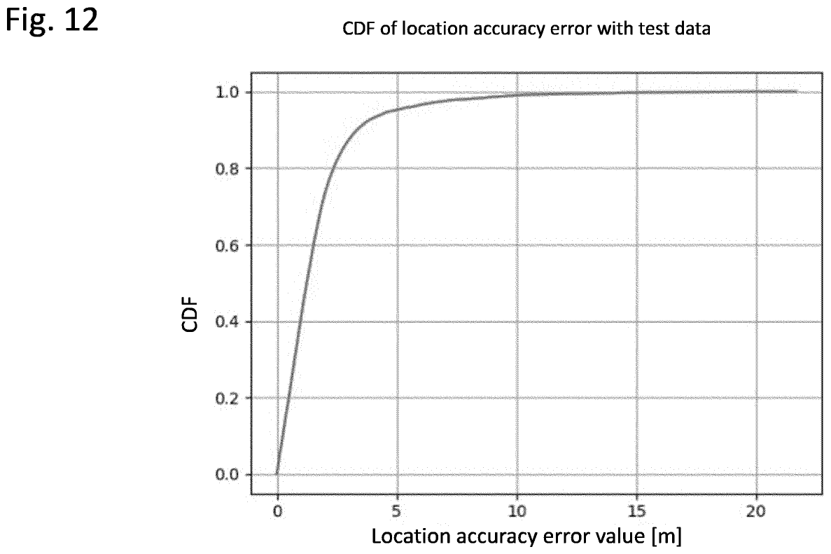

FIG. 12 shows the performance when applying the trained NN model to the test data. This Figure shows the CDF (cumulative distribution function) plotted against the location accuracy error value in m. In this simulation, ML model is able to evaluate the achieved location accuracy with a mean error of around 1.7 m (with a standard deviation of 1.9 m).

In some example embodiments, the ML model(s) may be added in the NWDAF and/or the LMF of the 5G Network. The Service Based API of the NWDAF may be enhanced to support location related inputs and/or outputs.

It is noted that while the above described example embodiments, there are several variations and modifications which may be made to the disclosed solution without departing from the scope of the present invention.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any of the above procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1.-38. (canceled)

39. An apparatus, comprising:
at least one processor, and
at least one memory including computer code, the at least one memory and the computer code configured, with the at least one processor, to cause the apparatus at least to:
receive a request for a location of a communication device with information indicating a target location quality of service associated with said location; and
in response to said information, determine a location method from a plurality of location methods to use and one or more parameters for said determined location method.

40. The apparatus of claim 39,
wherein the location quality of service of said location comprises a location accuracy.

41. The apparatus of claim 39, wherein the at least one memory and the computer code are further configured, with the at least one processor, to cause the apparatus at least to:
use the determined location method with the one or more parameters to determine said location for said communication device.

42. The apparatus of claim 41, wherein the at least one memory and the computer code are further configured, with the at least one processor, to cause the apparatus at least to:
determine a location quality of service of said determined location for said communication device.

43. The apparatus of claim 42, wherein the at least one memory and the computer code are further configured, with the at least one processor, to cause the apparatus at least to:
use a different location method and a different parameter to determine the location for said communication device when said determined location quality of service of said determined location does not meet the target location quality of service.

44. The apparatus of claim 42, wherein the at least one memory and the computer code are further configured, with the at least one processor, to cause the apparatus at least to:
determine the location quality of service of said determined location based on a trained neural network.

45. The apparatus of claim 44,
wherein said trained neural network is trained with respect to at least one of the location methods.

46. The apparatus of claim 44,
wherein said trained neural network is trained offline.

47. The apparatus of claim 39,
wherein the information indicating the target location quality of service comprises at least one of:
a quality of service (QoS) class, or
a required latency.

48. The apparatus of claim 39,
wherein a parameter of said one or more parameters comprises assistance data for said communication device.

49. An apparatus, comprising:
at least one processor, and
at least one memory including computer code, the at least one memory and the computer code configured, with the at least one processor, to cause the apparatus at least to:
use a location method with one or more parameters to determine a location for a communication device;
determine a location quality of service of said location; and
if said determined location quality of service does not meet a target location quality of service for said position, use a different location method and a different parameter.

50. The apparatus of claim 49, wherein the at least one memory and the computer code are configured, with the at least one processor, to cause the apparatus at least to:
determine the location quality of service of said determined location based on a trained neural network.

51. The apparatus of claim 50,
wherein said trained neural network is trained at least with respect to the determined location method.

52. The apparatus of claim 50,
wherein said trained neural network is trained offline.

53. The apparatus of claim 49, wherein the at least one memory and the computer code are further configured, with the at least one processor, to cause the apparatus at least to:
receive a request for said location of the communication device with information indicating the target location quality of service associated with said location.

54. The apparatus of claim 53, wherein the at least one memory and the computer code are further configured, with the at least one processor, to cause the apparatus at least to:
determining which of a plurality of location methods to use and one or more parameters for said determined location method based on said information.

55. The apparatus of claim 49,
wherein the determined location quality of service of said location comprises a location accuracy.

56. The apparatus of claim 53,
wherein the information indicating the target location quality of service comprises at least one of:
a quality of service (QoS) class, or
a required latency.

57. The apparatus of claim 54,
wherein a parameter of said one or more parameters comprises assistance data for said communication device.

58. An apparatus, comprising:
at least one processor, and
at least one memory including computer code, the at least one memory and the computer code configured, with the at least one processor, to cause the apparatus at least to:
use a trained neural network model to determine an accuracy of a determined position for a communication device using a location method of a plurality of different location methods,
wherein said neural network model is trained offline using at least one training set of data for the location method of the plurality of different location methods.
